(19) United States
(12) Patent Application Publication
(10) Pub. No.: US 2018/0203372 A1
(43) Pub. Date: Jul. 19, 2018

(54) WHITE TONER AND IMAGE FORMATION APPARATUS

(71) Applicant: Oki Data Corporation, Tokyo (JP)

(72) Inventor: Hiroshi TAKANO, Tokyo (JP)

(73) Assignee: Oki Data Corporation, Tokyo (JP)

(21) Appl. No.: 15/866,507

(22) Filed: Jan. 10, 2018

(30) Foreign Application Priority Data
Jan. 17, 2017 (JP) 2017-006057

(51) Int. Cl. G03G 9/09; G03G 9/097; G03G 9/087; G03G 9/08

(52) U.S. Cl. CPC G03G 9/0902; G03G 9/09733; G03G 9/08766; G03G 9/08755; G03G 9/0817; G03G 9/08702; G03G 9/0821; G03G 9/0808; G03G 9/08764

(57) ABSTRACT

A white toner according to an embodiment includes: a raw white toner not containing a colloidal silica and containing a white pigment and a crystalline resin; and 1.0 to 1.1 parts by weight of a colloidal silica per 100 parts by weight of the raw white toner. The white toner has a true density of 1.8 to 2.2 g/cm³.

### CROSS REFERENCE TO RELATED APPLICATIONS

This application claims priority based on 35 USC 119 from prior Japanese Patent Application No. 2017-006057 filed on Jan. 17 2017, entitled “WHITE TONER AND IMAGE FORMATION APPARATUS”, the entire contents of which are incorporated herein by reference.

### BACKGROUND

The disclosure relates to a white toner and image formation using the white toner in an electrophotographic color printer.

As external additives added to a white toner, fine powders of hydrophobic silica, fine powders of colloidal silica having a larger average particle size than fine powers of hydrophobic silica, and fine powders of melamine resin are used. Among them, the fine powders of colloidal silica function as a buffer against the load exerted on the toner in an image formation unit, preventing the exertion of the load from embedding the fine powders of hydrophobic silica into toner matrix particles. This prevents a developer from having low fluidity, thereby allowing improvement in image quality (see, for example, Patent Document 1: Japanese Patent Application Publication No. 2012-242492 (page 7, FIG. 2)).

### SUMMARY

A regular white toner needs addition of a large amount of metallic pigment such as titanium oxide to have sufficient density, and this makes it difficult for the toner to be charged sufficiently, resulting in fogging. Further, when a crystalline resin is added for better fixing performance of the toner, transferability is degraded. Thus, charge performance needs to be improved to reduce fogging toner while achieving sufficient fixing performance at low temperature and transferability.

An aspect is a white toner that includes: a raw white toner not containing a colloidal silica but containing a white pigment and a crystalline resin; and 1.0 to 1.1 parts by weight of a colloidal silica per 100 parts by weight of the raw white toner, wherein the white toner has a true density of 1.8 to 2.2 g/cm³.

According to the above aspect, the white toner may reduce transfer unevenness and fogging while achieving sufficient fixing performance.

### BRIEF DESCRIPTION OF THE DRAWINGS

FIG. 1 is a configuration diagram schematically illustrating a general configuration of an image formation apparatus 1 that uses a white toner according to Embodiment 1.

FIG. 2 is a graph illustrating the relation between blow-off charge and drum fogging of the white toner.

FIG. 3 is a diagram illustrating the relation between the additive amount of charge control resin (CCR) and blow-off charge.

### DETAILED DESCRIPTION

Descriptions are provided hereinbelow for embodiments based on the drawings. In the respective drawings referenced herein, the same constituents are designated by the same reference numerals and duplicate explanation concerning the same constituents is omitted. All of the drawings are provided to illustrate the respective examples only.

### Embodiment 1

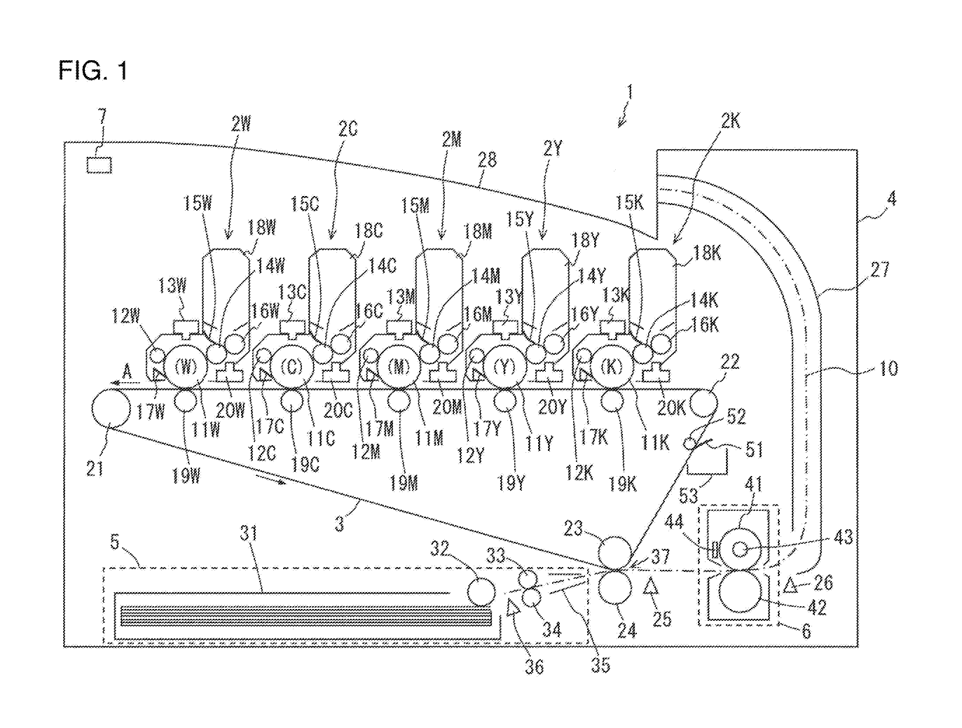

FIG. 1 is a configuration diagram schematically illustrating a general configuration of an image formation apparatus 1 that uses a white toner according to Embodiment 1.

The image formation apparatus 1 is, for example, configured as an electrophotographic color printer, and has five independent image formation units 2K, 2Y, 2M, 2C, and 2W inside a housing 4 of the image formation apparatus 1. The image formation units 2K, 2Y, 2M, 2C, and 2W correspond to black (K), yellow (Y), magenta (M), cyan (C), and white (W), respectively, and are arranged one after another in a conveyance direction of an intermediate transfer belt 3 (i.e., the direction of the arrow A). The image formation units 2K, 2Y, 2M, 2C, and 2W may be referred to simply as an image formation unit 2 when distinction is not particularly necessary. The image formation units 2K, 2Y, 2M, 2C, and 2W constitute an image formation section.

The image formation unit 2K forms a black (K) toner image, the image formation unit 2Y a yellow (Y) toner image, the image formation unit 2M a magenta (M) toner image, the image formation unit 2C a cyan (C) toner image, and the image formation unit 2W a white (W) toner image.

Although the present embodiment describes, as an example, the image formation apparatus 1 including the five image formation units 2 employing an intermediate transfer method, the present invention is not limited to such a configuration. As long as the image formation unit 2W for a white toner is located most downstream among the successive image formation units 2 (i.e., as long as the image formation unit 2W is located in such a position that the white toner forms the lowermost layer when toner images are transferred onto a print medium by one path), there is no limitation regarding the other image formation units 2K, 2Y, 2M, and 2C, such as the order of their arrangement and the numbers of them.

The five image formation units 2 have the same configuration, with the only difference being the toners they use. Thus, the configuration is described taking the image formation unit 2K as an example.

The image formation unit 2K includes a photosensitive drum 11K as a toner image carrier, a charge roller 12K that charges the surface of the photosensitive drum 11K uniformly and evenly, a developer roller 14K as a development part that forms a visible black (K) toner image by attaching a black (K) toner (not shown) to an electrostatic latent image formed on the surface of the photosensitive drum 11K, a supply roller 16K provided in contact with the developer roller 14K, and a cleaning blade 17K that scrapes off and processes fogging toner and transfer residual toner remaining on the surface of the photosensitive drum 11K as well as toner reversely transferred from the upstream image formation unit 2.

The supply roller 16K supplies the developer roller 14K with a black toner, which is a developer, stored in and supplied from a toner cartridge 18K. A doctor blade 15K is in pressure contact with the developer roller 14K. The doctor blade 15K forms the toner supplied from the supply roller 16K into a thin film on the developer roller 14K.

Similarly, the other image formation units 2Y, 2M, 2C, and 2W respectively include photosensitive drums 11Y, 11M, 11C, and 11W (or simply photosensitive drums 11 when distinction is not particularly necessary), charge rollers 12Y, 12M, 12C, and 12W (or simply charge rollers 12 when distinction is not particularly necessary), developer rollers 14Y, 14M, 14C, and 14W (or simply developer rollers 14 when distinction is not particularly necessary), supply rollers 16Y, 16M, 16C, and 16W (or simply supply rollers 16 when distinction is not particularly necessary), cleaning blades 17Y, 17M, 17C, and 17W (or simply cleaning blades 17 when distinction is not particularly necessary), toner cartridges 18Y, 18M, 18C, and 18W (or simply toner cartridges 18 when distinction is not particularly necessary), and doctor blades 15Y, 15M, 15C, and 15W (or simply doctor blades 15 when distinction is not particularly necessary).

The image formation units 2K, 2Y, 2M, 2C, and 2W further include LED heads 13K, 13Y, 13M, 13C, and 13W (or simply LED heads 13 when distinction is not particularly necessary), respectively. The LED heads 13K, 13Y, 13M, 13C, and 13W are located above and facing the photosensitive drums 11K, 11Y, 11M, 11C, and 11W, respectively. Each LED head 13 has a plurality of light-emitting devices (LED) arranged in the main scanning direction, and exposes the corresponding photosensitive drum 11 to light according to image data on the corresponding color inputted from a host computer, so that an electrostatic latent image may be formed on the surface of the photosensitive drum 11.

In the image formation apparatus 1, first transfer rollers 19K, 19Y, 19M, 19C, and 19W (or simply first transfer rollers 19 when distinction is not particularly necessary) are arranged below the corresponding photosensitive drums 11K, 11Y, 11M, 11C, and 11W, with the intermediate transfer belt 3 interposed between them. Each first transfer roller 19 presses the intermediate transfer belt 3 against the photosensitive drum 11, transferring a toner image onto the intermediate transfer belt 3 as first transfer.

In addition, up-and-down solenoids 20K, 20Y, 20M, 20C, and 20W (or simply up-and-down solenoids 20 when distinction is not particularly necessary) are attached to the respective image formation units 2. Each up-and-down solenoid 20 moves the corresponding image formation unit 2 up and down to bring the photosensitive drum 11 of the image formation unit 2 into or out of contact with the intermediate transfer belt 3. In other words, the up-and-down solenoid 20 switches the image formation unit 2 between an in-contact state where the image formation unit 2 is in contact with the intermediate transfer belt 3 and an out-of-contact state where the image formation unit 2 is out of contact with the intermediate transfer belt 3.

To bring the image formation unit 2 into the out-of-contact state, the up-and-down solenoid 20 moves the image formation unit 2 to an out-of-contact-state holding member (not shown), and to bring the image formation unit 2 to the in-contact state, the up-and-down solenoid 20 releases the image formation unit 2 from the out-of-contact-state holding member and brings the image formation unit 2 into contact with the intermediate transfer belt 3.

The intermediate transfer belt 3 is formed of a seamless, endless semiconductor plastic film with high resistance, and runs over a driver roller 21, a driven roller 22, and a second transfer opposite roller 23 with a predetermined level of tension. The driver roller 21 is rotated by a belt motor and conveys the intermediate transfer belt 3 in the arrow A direction in FIG. 1. The driven roller 22 is co-rotated by the intermediate transfer belt 3.

Here, the intermediate transfer belt 3 is so set as to move horizontally while conveyed between the driven roller 22 and the driver roller 21 in the conveyance direction (i.e., the arrow A direction), and the five image formation units 2 are arranged along the horizontal moving path in the order as described earlier. While moving through this horizontal moving region, the intermediate transfer belt 3 moves between the photosensitive drums 11 of the image formation units 2 and their opposite first transfer rollers 19.

The intermediate transfer belt 3 is pressed by the first transfer rollers 19 against the opposite photosensitive drums 11, and forms first transfer nip portions with the photosensitive drums 11 by coming into contact with the photosensitive drums 11. In these first transfer nip portions, predetermined DC voltages are applied from a first transfer voltage generator (not shown) to the first transfer rollers 19, and toner images on the respective photosensitive drums 11 are transferred and superimposed onto the intermediate transfer belt 3 sequentially.

The image formation apparatus 1 includes a sheet feeder mechanism 5 inside the housing 4, or particularly, below the image formation units 2 and the intermediate transfer belt 3. The sheet feeder mechanism 5 supplies a recording sheet to a conveyance path 10, and includes a sheet housing cassette 31, a hopping roller 32, a pinch roller 33, a registration roller 34, a guide 35, and a sheet feed sensor 36.

The sheet housing cassette 31 houses a stack of recording sheets, and the hopping roller 32 feeds one of the recording sheets housed in the sheet housing cassette 31 to the pinch roller 33 and the registration roller 34. The pinch roller 33 corrects the sheet for, if any, skew (a state where the sheet is being obliquely fed), and the registration roller 34 feeds the recording sheet to a second transfer roller 24 located at a position opposite the second transfer opposite roller 23 across the intermediate transfer belt 3. The guide 35 guides a recording sheet to the second transfer roller 24, and the sheet feed sensor 36 detects when a recording sheet reaches the region between the pinch roller 33 and the registration roller 34.

The second transfer roller 24 is co-rotated by the intermediate transfer belt 3, and the intermediate transfer belt 3 is pressed against the second transfer opposite roller 23 by the second transfer roller 24. The second transfer roller 24 and the intermediate transfer belt 3 form a second transfer nip portion 37 by coming into contact with each other. In the second transfer nip portion, a predetermined DC voltage is applied from a second transfer voltage generator (not shown) to the second transfer roller 24, and toner images transferred to the intermediate transfer belt 3 as first transfer are transferred onto a recording sheet as second transfer.

The image formation apparatus 1 includes a fixing device 6 downstream of the second transfer nip portion 37 in the sheet conveyance direction of the conveyance path 10, and a second transfer discharge sensor 25 is provided between the second transfer roller 24 and the fixing device 6. The second transfer discharge sensor 25 monitors whether a recording sheet is stuck on the second transfer roller 24, whether a recording sheet is separated from the intermediate transfer belt 3, and the like.

The fixing device 6 includes a heat roller 41, a pressure roller 42, a heater 43, and a thermistor 44. The heater roller 41 is driven by a heater motor (not shown). The pressure roller 42 is so placed as to sandwich the conveyance path 10 with the heat roller 41, is co-rotated by the heat roller 41, and applies pressure to the heat roller 41. The heater 43 is formed of a halogen lamp or the like serving as a heat source, and is provided inside the heat roller 41 to heat the heat roller 41. The thermistor 44 is placed near the surface of the heat roller 41 to measure the surface temperature of the heat roller 41.

The fixing device 6 heats and fuses toners on a recording sheet conveyed between the heat roller 41 and the pressure roller 42 along the conveyance path 10 to fix the toner images onto the recording sheet. The image formation apparatus 1 has a fixing discharge sensor 26 downstream of the fixing device 6 in the sheet conveyance direction of the conveyance path 10. The fixing discharge sensor 26 monitors whether jamming is occurring in the fixing device 6, whether a recording sheet is stuck on the heat roller 41, and the like.

The image formation apparatus 1 is provided with a guide 27 at a position downstream of the fixing discharge sensor 26 in the sheet conveyance direction of the conveyance path 10. The guide 27 guides a printed recording sheet to a stacker 28 provided in an upper part of the housing 4, and discharges the printed recording sheet onto the stacker 28. In addition, a cleaning blade 51 is placed downstream of the second transfer nip portion 37 in the moving direction of the intermediate transfer belt 3 (i.e., the arrow A direction), and removes second transfer residual toner not transferred onto a recording sheet in the second transfer and remaining on the intermediate transfer belt 3.

The cleaning blade 51 is placed at a position opposite from an opposite roller 52 across the intermediate transfer belt 3, is made of a flexible rubber or plastic material, and scrapes off second transfer residual toner remaining on the intermediate transfer belt 3 into a waste toner tank 53.

Also, the image formation apparatus 1 has an environment sensor 7 inside the housing 4 to measure the temperature and humidity as environmental conditions. Based on the temperature and humidity measured by the environment sensor 7, the image formation apparatus 1 determines, before print operation is started, which of the image formation units 2 to bring into or out of contact with the intermediate transfer belt 3, and switches each image formation unit 2 between the in-contact state and the out-of-contact state.

In one embodiment, a binder resin for use in a toner is a thermoplastic resin such as vinyl resins, polyamide resins, polyester resins, and polyurethane resins. A solvent usable as an organic solvent in which to dissolve the binder resin using a dissolution suspension method may be, for example, a hydrocarbon solvent like ethyl acetate, xylene, or hexane, an ester solvent such as methyl acetate, ethyl acetate, butyl acetate, or isopropyl acetate, an ether solvent such as diethyl ether, and a ketone solvent such as acetone, methyl ethyl ketone, diisobutyl ketone, cyclohexanone, or methylcyclohexane.

Various materials may be used for the crystalline resin. For example, when the binder resin is a polyester resin, the crystalline resin is preferably a polyester resin from the perspective of its dispersibility in the binder resin.

Examples of a release agent include higher fatty acids, metal salts of higher fatty acids, fatty acid amides, ester waxes, paraffin polyolefin waxes, or aliphatic hydrocarbon waxes which are modified substances of paraffin polyolefin waxes.

Examples of the charge control agent (CCR) for, for example, a negatively charged toner include azo complex charge control agents, salicylic acid complex charge control agents, or calixarene complex charge control agents.

Possible white pigments include various metallic pigments used as white pigments, such as titanium oxide, aluminum oxide, and zinc sulfate.

A suspension stabilizer used in the dissolution suspension method is preferably one that is removable by acid, which has no affinity for the solvent, because toner particles are formed with the suspension stabilizer being attached to the particle surfaces after dispersion. Examples of such a stabilizer include calcium carbonate, calcium chloride, sodium hydrocarbon, potassium hydrocarbon, hydroxyapatite, and tricalcium phosphate.

Now, descriptions are given of tests performed on the white toner according to the embodiment used by the image formation apparatus 1. The white toner is, for example, obtained by a manufacturing method involving kneading a mixture of at least a white pigment (e.g., titanium oxide), a binder resin (e.g., polyester), a crystalline resin, a release agent, and a charge control resin (CCR), crushing the mixture, obtaining particles of a predetermined particle size by classification, and adding a proper amount of colloidal silica as part of external additives.

For clarification of the descriptions, a white toner before the addition of colloidal silica (i.e., a white toner containing no colloidal silica) is referred to as a raw white toner, and a white toner after the addition of colloidal silica (i.e., a white toner containing colloidal silica) is called a white toner. A white toner which is irrespective of whether colloidal silica has been added is also called a white toner.

### (Test A)

A crystalline resin may be added to a white toner in order to enhance its fixing performance at low temperatures. This, however, degrades transferability. The present embodiment uses a proper amount of colloidal silica as part of external additives to compensate for the transferability degradation so that the transferability may not be lowered. To determine the range of proper additive amounts of colloidal silica, a transfer margin and fixing performance are tested as Test A for samples of a white toner the true density of which is from 1.8 to 2.2 g/cm³. The samples are prepared by adding colloidal silica in amounts adjusted in a range from 0.75 to 1.2 parts by weight per 100 parts by weight of the raw white toner, i.e., a white toner before the addition of colloidal silica.

First, adjustment is performed for 100% solid area density by printing a color toner solidly on a piece of OKI Excellent White paper (which is manufactured by Oki Data Corporation, 80 g/m² in weight, and A4 in size), measuring its density with a spectrophotometer (X-Rite 528 manufactured by X-Rite, Incorporated), and adjusting the layer thickness of the color toner so that the density may be 1.40. The layer thickness of the color toner obtained by such an adjustment is 0.40 mg/cm².

Regarding the density of a white toner, a white toner is printed solidly on blue paper, its hue is measured with a spectrophotometer (X-Rite 528), and the layer thickness of the white toner is adjusted so that the L* value may be 83. The layer thickness of the white toner obtained by such an adjustment is 0.90 mg/cm².

Under the above conditions, for 100% printing of white, a range of favorable first transfer is obtained in which first transfer efficiency for the white toner is 90% or above. Similarly, for the total of 340% printing using 80% of a yellow (Y) toner, 80% of a magenta (M) toner, 80% of a cyan (C) toner, and 100% of a white (W) toner, a range of favorable first transfer is obtained in which the first transfer efficiency for the white toner is 90% or above.

With a transfer margin being the overlap between the favorable range of the 100% printing and the favorable range of the 340% printing, the target of the transfer margin is set to 700 V or above. This transfer margin target is so set as to be able to accommodate various levels of temperature and humid and various types of print media. Table 1 illustrates the relation between the amount of colloidal silica and the transfer margin.

TABLE 1

| Colloidal | Favorable first | Favorable first | | | |
|---|---|---|---|---|---|
| silica | transfer range | transfer range | Transfer | | |
| amount | (100%) | (340%) | margin | Judgement | Remark |
| 0.75 | 370 V to 1120 V | 480 V to 1450 V | 640 V | Failed | |
| 1.0 | 310 V to 1110 V | 360 V to 1560 V | 750 V | Passed | |
| 1.1 | 290 V to 1190 V | 330 V to 1500 V | 860 V | Passed | |
| 1.2 | 260 V to 1180 V | 340 V to 1490 V | 840 V | Failed (*) | Fixing |
| | | | | | unsuccessful |

As Table 1 illustrates, when the amount of colloidal silica is 0.75 parts by weight, the transfer margin does not reach its target, failing the judgement. When the amount of colloidal silica is 1.0 parts by weight or more, the transfer margin reaches the target. However, when the amount of colloidal silica is 1.2 parts by weight, the fixing performance at low temperatures degrades, failing the judgement. Judging from the above, a white toner can reduce transfer unevenness while achieving sufficient fixing performance when the amount of colloidal silica is from 1.0 to 1.1 parts by weight per 100 parts by weight of toner.

### (Test B)

Samples of the white toner determined in Test A above are prepared, the samples containing different additive amounts of charge control resin (CCR), and are then tested to check the relation between blow-off charge and drum fogging.

To measure the blow-off charge, 9.7 g of carrier N-01 (the Imaging Society of Japan) and 0.3 g of white toner are placed in a container and agitated by a shaking device (YS-LD: Yayoi Co., Ltd.) 200 strokes a minute for ten minutes, and the charged toner is measured with a powder charge amount measurement device (TYPE TB-203: KYOCERA Chemical Corporation).

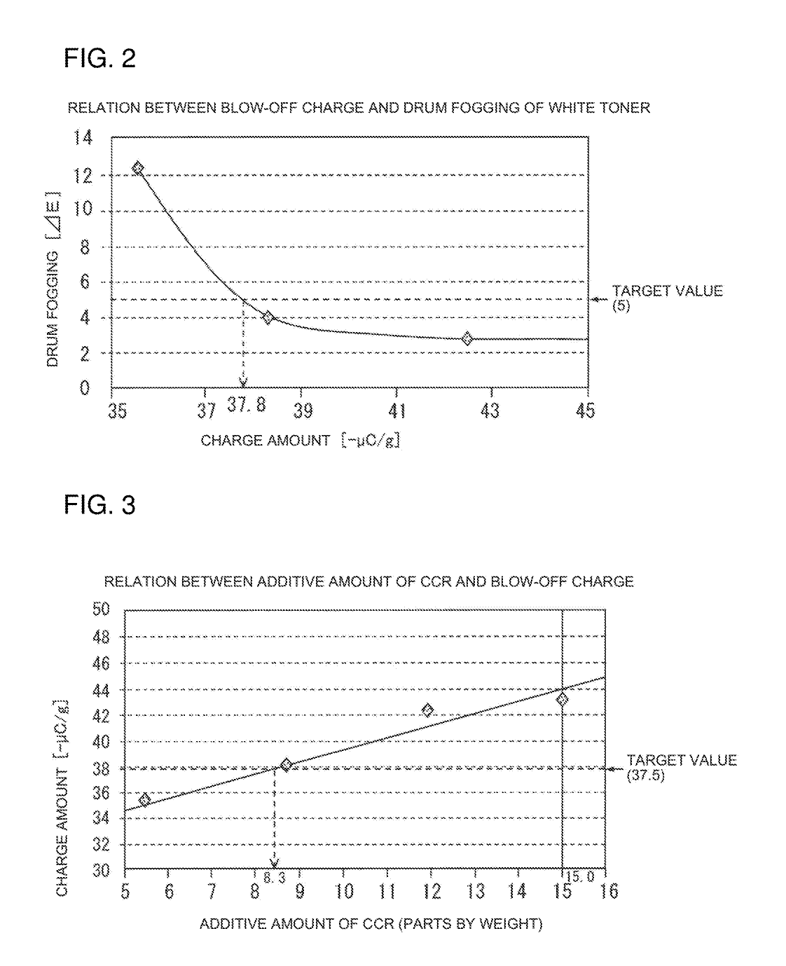

Drum fogging of the white toner the charge amount of which has been measured is collected. The results are illustrated in FIG. 2 as a graph of the relation between the blow-off charge and the drum fogging of the white toner. As can be seen in FIG. 2, the larger the blow-off charge amount of the white toner, the lower the drum fogging (color difference Δ). FIG. 2 also suggests that, in order to obtain a target value of drum fogging (color difference Δ) which is set to five or smaller, the blow-off charge value needs to be 37.8-μC/g or above. The reason why the target value of drum fogging (color difference Δ) is set to five or smaller is because the fogging is ignorable on printed paper when the drum fogging (color difference Δ) is five or smaller.

Note that the color difference ΔE is the numerical value of a fogging level measured on the photosensitive drum (e.g., the photosensitive drum 11W).

Next, FIG. 3 illustrates the relation between the additive amount of charge control resin (CCR) and the blow-off charge of the white toner determined by Test A above. As can be seen in FIG. 3, when the additive amount of the charge control resin (CCR) is 8.3 parts by weight or more per 100 parts by weight of the raw white toner, the blow-off charge amount can reach the necessary amount described above, 37.8-μC/g or above.

When the additive amount of charge control resin (CCR) exceeds 15.0 parts, however, the range of favorable second transfer voltage is reduced, leading to transfer unevenness. Thus, the maximum additive amount of charge control resin (CCR) is set to 15.0 parts by weight.

Typically, the true density of a color toner is from 1.0 to 1.5 g/cm³, and the true density of a white toner is from 1.8 to 2.2 g/cm³. Since toners on sale basically have the same particle size (e.g., 7 μm), the weight of toner per particle is heavier for a white toner than for a color toner.

One advantageous effect produced by adding colloidal silica is that “by having spacers, toner adheres to a photosensitive body less strongly, and is transferred to the photosensitive body more easily. Since the weight of toner per particle is heavier for a white toner, a white toner adheres to a photosensitive body more strongly than a color toner. For this reason, more colloidal silica may be necessary for a white toner in order for transfer efficiency and transfer margin to be enhanced by the adhesiveness reduction. Note that in a case of a metallic white pigment, the white pigment is preferably contained in an amount of 2 to 25 parts by weight per 100 parts by weight of the binder resin.

According to the embodiment described above, a white toner with a true density of 1.8 to 2.2 g/cm³ is obtained by adding a colloidal silica to a raw white toner not containing a colloidal silica but containing a white pigment, a crystalline resin, and a charge control resin (CCR), the raw white toner containing the charge control resin (CCR) in an amount of 8.3 to 15.0 parts by weight per 100 parts by weight of the raw white toner, the colloidal silica being added in an amount of 1.0 to 1.1 parts by weight per 100 parts by weight of the raw white toner. Thereby, the white toner can have a blow-off charge amount of 37.8 μC/g or above, and can reduce transfer unevenness and fogging while achieving sufficient fixing performance.

Although applied to an electrophotographic color printer in the embodiment described above, the invention is not limited to such an example, and can be used also for other apparatuses such as a multifunction printer (MFP), a facsimile machine, and a copier.

The invention includes other embodiments in addition to the above-described embodiments without departing from the spirit of the invention. The embodiments are to be considered in all respects as illustrative, and not restrictive. The scope of the invention is indicated by the appended claims rather than by the foregoing description. Hence, all configurations including the meaning and range within equivalent arrangements of the claims are intended to be embraced in the invention.

1. A white toner comprising:
a raw white toner not containing a colloidal silica and containing a white pigment and a crystalline resin; and
1.0 to 1.1 parts by weight of a colloidal silica per 100 parts by weight of the raw white toner, wherein
the white toner has a true density of 1.8 to 2.2 g/cm³.

2. The white toner according to claim 1, wherein
a blow-off charge value of the white toner is 37.8-μC/g or above.

3. The white toner according to claim 1, wherein
the raw white toner contains 8.3 to 15.0 parts by weight of a charge control resin per 100 parts by weight of the raw white toner.

4. The white toner according to claim 1, wherein
the raw white toner is obtained in such a way that a mixture of the white pigment, a binder resin, the crystalline resin, a release agent, and a charge control resin (CCR) is kneaded and crushed, followed by classification according to a predetermined particle size.

5. The white toner according to claim 4, wherein
the white pigment comprises at least one of titanium oxide, aluminum oxide, and zinc sulfate.

6. The white toner according to claim 4, wherein
the binder resin comprises at least one type of thermoplastic resins including vinyl resins, polyamide resins, polyester resins, and polyurethane resins.

7. The white toner according to claim 4, wherein
the release agent comprises at least one of higher fatty acids, metal salts of higher fatty acids, fatty acid amides, ester waxes, paraffin polyolefin waxes, and aliphatic hydrocarbon waxes.

8. The white toner according to claim 4, wherein
the crystalline resin comprises a polyester resin.

9. The white toner according to claim 4, wherein
the charge control resin comprises at least one of azo complex charge control agents, salicylic acid complex charge control agents, and calixarene complex charge control agents.

10. The white toner according to claim 4, wherein
the white pigment is a metallic white pigment, a content of which is 2 to 25 parts by weight per 100 parts by weight of the binder resin.

11. An image formation apparatus employing an intermediate transfer method, the apparatus comprising an image formation section that forms toner images using the white toner according to claim 1 and a color toner.

12. The image formation apparatus according to claim 11, wherein
the color toner has a true density of 1.0 to 1.5 g/cm³.

13. The image formation apparatus according to claim 11, wherein
the image formation section includes
a first toner image carrier,
a second toner image carrier,
a first toner cartridge that houses the white toner according to claim 1,
a second toner cartridge that houses the color toner,
a first development part that forms a white toner image by supplying the first toner image carrier with the white toner from the first toner cartridge, and
a second development part that forms a color toner image by supplying the second toner image carrier with the color toner from the second toner cartridge.

14. A method of manufacturing a white toner, comprising:
preparing a raw white toner containing no colloidal silica and containing a white pigment and a crystalline resin; and
adding 1.0 to 1.1 parts by weight of a colloidal silica per 100 parts by weight of the raw white toner, thereby obtaining a white toner with a true density of 1.8 to 2.2 g/cm³.
